(19) United States
(12) Patent Application Publication
(10) Pub. No.: US 2010/0269276 A1
(43) Pub. Date: Oct. 28, 2010

(54) Small Electrical Appliance Having An Indicator Element

(75) Inventors: Leo Faranda, Rodgau (DE); Alexander Hilscher, Oberursel (DE); Frank Stefan Skopp, Eschborn (DE); Frank Mueller, Oberursel (DE); Norbert Schaefer, Frankfurt (DE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/766,198

(22) Filed: Apr. 23, 2010

(30) Foreign Application Priority Data
Apr. 23, 2009 (EP) 09 005 703.5

(51) Int. Cl. A46B 13/02; A61C 17/00

(52) U.S. Cl. 15/22.1

(57) ABSTRACT

A small electrical appliance is provided. The small electrical appliance includes a switch element having an on position and an off position that can be activated by a user; an indicator element having a first function and a second function; and a control unit for monitoring the switch element and for controlling the indicator element. The small electrical appliance includes a first operating condition and a second operating condition. And the control unit activates the indicator element to indicate the first function when the small electrical appliance is in the first operating condition and the switch element is in the off position, and the control unit activates the indicator element to indicate the second function when the small electrical appliance is in the first operating condition and the switch element is in the on position.

### CROSS REFERENCE TO RELATED APPLICATION

This application claims the benefit of European Patent Convention Application No. 09005703.5, filed Apr. 23, 2009, the substance of which is incorporated herein by reference.

### FIELD OF THE INVENTION

The present disclosure relates generally to small electrical appliances, and more particularly, to an electric toothbrush or an electric razor, having an indicator element.

### BACKGROUND OF THE INVENTION

An electric toothbrush having an indicator element to warn if the contact pressure of the toothbrush is too high during brushing is disclosed in U.S. Pat. No. 6,954,961 B2. If the contact pressure exceeds a certain threshold value, a warning light is activated. Such a toothbrush is intended to relieve users of the fear of brushing their teeth and their gum edge too aggressively and to assist them in brushing with the correct contact pressure.

However, it is difficult for a consumer to recognize whether an electric toothbrush has this function when the toothbrush is in the packaging or in the store window. Therefore so-called demo boards were developed on which various models of electric toothbrushes (each comprising a handle, a replacement brush, and a charging device) are mounted next to one another, on which the consumer can test the motor function or other functions. This is intended to facilitate the consumer's choice of the correct model.

It is furthermore known to build special small electrical appliances for demonstration purposes, with which the functions of a “normal” small electrical appliance can be illustrated.

It is therefore desirable to have a small electrical appliance whose functions can easily be recognized by a user. This need is achieved by a small electrical appliance that has a switch element that can be activated by a user, an indicator element, and a control unit for monitoring the switch element and for controlling the indicator element, and which can be in a first and in a second operating condition, and whose indicator element can indicate a first function and a second function, wherein the control unit activates the indicator element to indicate the first function when the small electrical appliance is in the first operating condition and is switched off, and the control unit activates the indicator element to indicate the second function when the small electrical appliance is in the first operating condition and is switched on.

### SUMMARY OF THE INVENTION

In one embodiment, the small electrical appliance includes a switch element having an on position and an off position that can be activated by a user; an indicator element having a first function and a second function; and a control unit for monitoring the switch element and for controlling the indicator element. The small electrical appliance includes a first operating condition and a second operating condition. And the control unit activates the indicator element to indicate the first function when the small electrical appliance is in the first operating condition and the switch element is in the off position, and the control unit activates the indicator element to indicate the second function when the small electrical appliance is in the first operating condition and the switch element is in the on position.

### BRIEF DESCRIPTION OF THE DRAWINGS

While the specification concludes with claims which particularly point out and distinctly claim the subject matter that is regarded as the invention, it is believed the various embodiments will be better understood from the following description taken in conjunction with the accompanying drawings, in which:

FIG. 1 is a perspective view of an electric toothbrush in accordance with one embodiment;

The FIGURE herein is not necessarily drawn to scale.

### DETAILED DESCRIPTION OF THE INVENTION

According to one embodiment, a small electrical appliance includes a switch element that can be activated by a user, an indicator element, and a control unit for monitoring the switch element and for controlling the indicator element, and which can be in a first and in a second operating condition, and whose indicator element can indicate a first function and a second function, wherein the control unit activates the indicator element to indicate the first function when the small electrical appliance is in the first operating condition and is switched off, and the control unit activates the indicator element to indicate the second function when the small electrical appliance is in the first operating condition and is switched on.

In one embodiment, a small electrical appliance can be moved into a first operating condition, in which the indicator element can carry out two different functions, for example, an advertising function as long as it is switched off, and an operating function when it is switched on by a user. In the second operating condition of the small electrical appliance, only the operating function is available in one embodiment. In another embodiment, both the advertising and operating functions are available in both first and second operating conditions.

In one embodiment, the control unit is also designed for monitoring the operating voltage of the small electrical appliance, and activates the indicator element to indicate the first function only when the operating voltage exceeds a minimum voltage. When the small electrical appliance also has a rechargeable battery, the control unit may include a design feature for monitoring a charging process, wherein the control unit activates the indicator element to indicate the first function only during a charging process and/or within a certain period of time after a charging process. In this manner, an excessive discharge of the rechargeable battery is prevented through the first indicator function.

In one embodiment, the advertising function comprises a blinking of the indicator element, which, for example, is switched on for 0.2 to 0.8 seconds and is then switched off for 1.6 to 8 seconds. In one embodiment, the factor between “On” and “Off” from 2 to 10, in another embodiment the factor is 5, in order to spare the battery and to obtain a long operational time if at some time the small electrical appliance is not connected to the charging device.

The small electrical appliance can, for example, be moved into the first operating condition in that the switch element is activated in a certain sequence and/or duration and the small electrical appliance is connected to a charging device for the rechargeable battery or is again detached from it. No additional control elements on the small electrical appliance are required for such an activation.

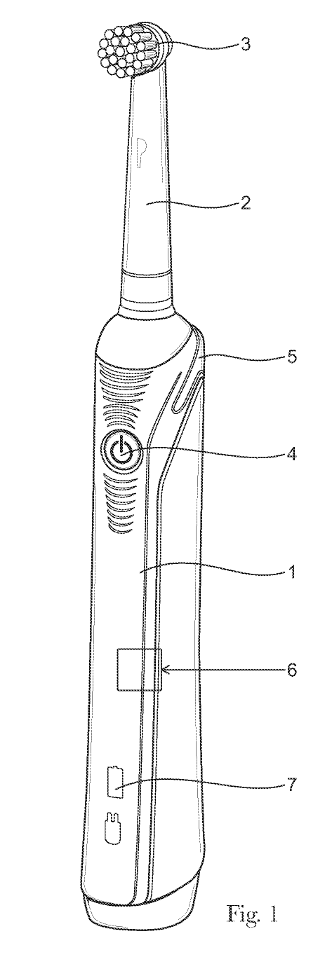

The invention is described below using an electric toothbrush 10 as an example, which is shown in FIG. 1. In the embodiment shown in FIG. 1, the toothbrush 10 comprises a handle 1 and a brush 2, which is provided with bristles 3 in a known manner and is connected to the handle. The handle 1 includes, for example, a button as a switch element 4 and an indicator element 5. The handle 1 contains a motor for driving the brush 2 and a control unit 6, only shown schematically, for monitoring the switch element 4 and for controlling the indicator element 5, which, for example, may compose a light-emitting diode. In one embodiment, the handle 1 may include a rechargeable battery.

The toothbrush 10 can be in a first and in a second operating condition. In the first operating condition, the indicator element has a first function, for example, an advertising function, as long as the toothbrush is switched off. In one embodiment, the first function of the control unit allows the light-emitting diode to blink in order to attract the attention of the customers to the toothbrush. If the customer switches the toothbrush on by means of the switch element 4, whereby, for example, the motor of the electric toothbrush is activated, the indicator element has a second function, namely an operating function. In one embodiment, the operating function serves to indicate a contact pressure that is too high when brushing teeth. If in fact a user stresses the brush 2 by pressing the bristles 3 against the teeth or presses the bristles 3 of the brush 2 with the fingers as a test, the control unit 6 ensures that the light-emitting diode 5 always lights when the customer exerts too high a pressure on the brush 2. For this purpose the toothbrush 10 is also provided with a sensor for the pressure exerted on the brush 2, which sensor is likewise connected to the control unit 6.

If the user switches the toothbrush off again by, for example, activating the switch element 4 again, the indicator element 5 is again used for its first function, namely the advertising function, in order to draw the attention of customers to itself.

If the small electrical appliance is in the second operating condition, the indicator element only has to indicate the operating function, i.e. when the toothbrush is switched on, the light-emitting diode lights in order to indicate too high a contact pressure if necessary, whereas it remains unlit when the toothbrush is switched off. Thus the advertising function is not activated independently of the activation of the switch element 4 in the second operating condition.

When the small electrical appliance is in the first operating condition and is switched off, the power consumption of the blinking light-emitting diode may be so high that the battery is quickly drained. An activation of the advertising function over a lengthy period of time is therefore not advisable. In one embodiment, the control unit ensures that the advertising function is activated only when the voltage of the battery exceeds a minimum voltage. For a small electrical appliance with a rechargeable battery, the control switching can also be designed such that it determines whether the small electrical appliance is connected to a charging device. If the control unit in this case is also provided with a timing device that determines the time elapsed since the separation of the small electrical appliance from the charging device, the advertising function can still be activated if the small electrical appliance is not separated from the charging device for too long a period of time. Therefore as long as the small electrical appliance is switched off and connected to the charging device, or the battery voltage is sufficiently high, the indicator element is operated in its first function.

In one embodiment, the control unit also controls the charging of the battery, in such a way that the battery is always fully charged as long as the small electrical device is connected to the charging device. This results in that the small electrical appliance in the first operating condition with the advertising function activated, is recharged more strongly than in the second operating condition without advertising function.

The switching-over of the small electrical appliance from its first operating condition into its second operating condition or vice versa, may take place in such a way that an accidental switching-over is largely avoided. The purpose for this is that usually the advertising function of the small electrical appliance is only important for marketing purposes, whereas customers are only interested in the operating function. The described small electrical appliance therefore has the advantage that it can be used both as a “normal device” for customers as well as a “demonstration device” for marketing purposes.

The switching-over of the small electrical appliance from its first operating condition into its second operating condition and vice versa is described below using an example. It is thereby assumed that the small electrical appliance has a rechargeable battery and an indicator 7 for the charging state of the battery, for example, an additional light-emitting diode, wherein the control unit 6 ensures that the charge indicator 7 lights continuously for a certain amount of time after the small electrical appliance has been connected to the charging device, and begins to blink after this certain amount of time. To switch the operating condition of the small electrical appliance, the button 4 is first pressed and is kept pressed during the following steps. The appliance is then placed on the charging device several times and detached from it again, wherein the detaching from the charging device sometimes already takes place when the charge indicator 7 remains continuously lit, and sometimes only when the charge indicator 7 has already begun to blink. Finally, the small electrical appliance is detached from the charging device and the button 4 is released.

Such a procedure ensures with sufficient certainty that a customer does not accidentally cause the switching-over from the one operating condition into the other. Further suitable procedures for switching the small electrical appliance from one operating condition into another are described in EP 0 894 039 B1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A small electrical appliance comprising:
a switch element having an on position and an off position that can be activated by a user;
an indicator element having a first function and a second function; and
a control unit for monitoring the switch element and for controlling the indicator element;
wherein the small electrical appliance includes a first operating condition and a second operating condition; and wherein the control unit activates the indicator element to indicate the first function when the small electrical appliance is in the first operating condition and the switch element is in the off position, and the control unit activates the indicator element to indicate the second function when the small electrical appliance is in the first operating condition and the switch element is in the on position.

2. The small electrical appliance according to claim 1, wherein when the small electrical appliance is in the second operating condition, the control unit activates the indicator element only to indicate the second function.

3. The small electrical appliance according to claim 1, wherein the control unit monitors the operating voltage of the small electrical appliance such that the control unit activates the indicator element to indicate the first function only when the operating voltage exceeds a minimum voltage.

4. The small electrical appliance according to claim 1, further comprising a rechargeable battery.

5. The small electrical appliance according to claim 4, wherein the control unit monitors a charging process such that the control unit activates the indicator element to indicate the first function only during a charging process and/or within a certain period of time after a charging process.

6. The small electrical appliance according to claim 1, wherein the indicator element comprises a light-emitting diode.

7. The small electrical appliance according to claim 6, wherein the first function of the indicator element is an advertising function and the second function is an operating function.

8. The small electrical appliance according to claim 7, wherein the advertising function comprises a blinking of the indicator element when the switch element is in the off position to attract the attention of customers.

9. The small electrical appliance according to claim 7, wherein the operating function comprises a lighting of the indicator element when the switch element is in the on position.

10. The small electrical appliance according to claim 9, wherein the indicator element lights only when a contact pressure between the user and the applicance is too high.

11. The small electrical appliance according to claim 4, further comprising an additional indicator to indicate the charging state of the battery.

12. The small electrical appliance according to claim 1, wherein the applicance is an electric toothbrush.
